(19) United States
(12) Patent Application Publication
(10) Pub. No.: US 2003/0048939 A1
(43) Pub. Date: Mar. 13, 2003

(54) Method of and apparatus for inspection of articles by comparison with a master

(75) Inventor: Yonatan Lehman, Moshav Bet Gamlill (IL)

Correspondence Address: SUGHRUE MION, PLLC, 1010 El Camino Real, Menlo Park, CA, 94025-4345, US

(73) Assignee: Applied Materials, Inc.

(21) Appl. No.: 10/287,168

(22) Filed: Oct. 31, 2002

Related U.S. Application Data
(63) Continuation of application No. 09/314,273, filed on May 18, 1999.

(51) Int. Cl. G06K 9/00

(52) U.S. Cl. 382/144

(57) ABSTRACT

A simple, powerful technique for facilitating defect inspection in manufactured articles, especially articles used in or resulting from semiconductor fabrication. In the case of an article having a chrome and glass pattern thereon, such as a reticle or other article used in photolithography, a master version is identified, in as pristine a fashion as possible. That master version is imaged and stored, and that image used subsequently for comparison to other correspondingly patterned articles as part of an inspection process. The data provided by reading the recorded image of the master article substitutes for data derived from prior Die to Die or Die to Database comparisons. The invention also is directed to an apparatus which enables the nonvolatile storage of one or more of such master versions for use in article inspection.

### BACKGROUND OF THE INVENTION

1. Field of the Invention

The present invention relates to inspection of articles, and in particular, to inspection of articles related to manufacture of semiconductor devices. More specifically, the invention relates to the inspection of articles used in photolithography during manufacture of semiconductor devices.

2. Description of the Background Art

Current demands for high density and performance associated with ultra large scale integration require submicron features, increased transistor and circuit speeds, and improved reliability. Such demands require formation of device features with high precision and uniformity, which in turn necessitates careful process monitoring.

One important process requiring careful inspection is photolithography, wherein masks or “reticles” are used to transfer circuitry patterns to semiconductor wafers. Typically, the reticles are in the form of patterned chrome over a transparent substrate. A series of such reticles are employed to project the patterns onto the wafer in a preset sequence. Each photolithographic reticle includes an intricate set of geometric patterns corresponding to the circuit components to be integrated onto the wafer. The transfer of the reticle pattern onto the photoresist layer is performed conventionally by an optical exposure tool such as a scanner or a stepper, which directs light or other radiation through the reticle to expose the photoresist. The photoresist is thereafter developed to form a photoresist mask, and the underlying polysilicon or metal layer is selectively etched in accordance with the mask to form features such as lines or gates.

From the above description, it should be appreciated that any defect on the reticle, such as extra or missing chrome, may transfer onto the fabricated wafer in a repeated manner. Thus, any defect on the reticle would drastically reduce the yield of the fabrication line. Therefore, it is of utmost importance to inspect the reticles and detect any defects thereupon. The inspection is generally performed by an optical system, using transmitted, reflected, or both types of illuminations. An example of such a system is the RT-8000™ series reticle inspection system available from Applied Materials of Santa Clara, Calif.

There are several different known algorithm methods for inspection of reticles. These methods include: “Die to Die” inspection, in which a die is compared to a purportedly identical die on the same reticle; or “Die to Database” inspection, in which data pertaining to a given die is compared to information in a database, which could be the one from which the reticle was generated. Examples of these inspection methods, and relevant apparatus and circuitry for implementing these methods, are described in various U.S. patents, including, inter alia, U.S. Pat. Nos. 4,805,123; 4,926,489; 5,619,429; and 5,864,394. The disclosures of these patents are incorporated herein by reference.

While Die to Die and Die to Database inspection algorithms are the predominantly used techniques, these techniques have particular limitations, as now will be discussed. In the first instance, it should be noted that inspection of the reticles is performed both at so-called mask shops” by the reticle manufacturers, and at the plants, or fabs, at which semiconductor wafers are manufactured. However, each of these entities usually employs one inspection technique, but not the other. For example, since the mask shops have the original database used to create the reticle, they generally use the Die to Database inspection method, though they also can use the Die to Die method. On the other hand, since the database is generally not available at the fab, the fab uses the Die to Die inspection method. When the mask shop uses a different technique from the one the fab uses, it is not possible to correlate the respective inspection results.

As a result, one desirable improvement would be to provide a method for mask and/or reticle inspection which is available to both entities (i.e. the mask shops and the fabs). Availability of such a method would allow for cross checking and comparison of inspection results.

Second, a particular general disadvantage of Die to Die inspection is that the reference used for the inspection is not necessarily perfect. That is, in the Die to Die method, one die is first compared to a neighboring die. If an inconsistency is discovered, it is flagged as a defect. However, merely identifying the inconsistency does not make it clear which die is defective. Therefore, another comparison must be made, this time to a third die. Then, the one that is different from the two others is flagged as the defective die. Even with this probabilistic approach, there still is no assurance that the correct die was flagged as defective. In particular, defects of a repeatable nature, i.e. defects that appear in all of the dies, cannot be ascertained in Die to Die inspection.

A further disadvantage of Die to Die inspection is the amount of setup required. The dies need to be aligned before reliable inspection can be performed. It would be desirable to limit the amount of setup that is required.

A still further disadvantage of Die to Die inspection is that it cannot handle the “single die” case, i.e. where there is only one die on the reticle or other article to be inspected, because there is nothing with which to compare that single die.

In Die to Database inspection, the database that is used is constituted by the data used to fabricate the masks or reticles. This data theoretically is “perfect”. However, there are limitations in the applicability of database information of this nature. For one thing, the database is written as a binary image, i.e., transparent and opaque areas. However, the image obtained from the inspection system is a gray scale image. Therefore, various algorithms are used to “binarize” the inspection image before comparing it to the binary database. Other algorithm methods are used to “smear” the binary database and compare the resulting “false” gray scale image to the inspection image. Each of these algorithm methods may introduce differences between the inspected image and the database that are not indicative of a defective reticle.

Another limitation of the Die to Database method is that the process used to create the reticle from the database introduces changes, so that the resulting reticle is somewhat different than the design database. A typical phenomenon is known as “comer rounding”; wherein square edges in the database are rounded when formed on the reticle. Such rounding can give rise to false alarms, since such effects are known and are accounted for in the manufacture of semiconductors. Another example is “biasing”—shrinking or expansion of features by small amounts. Modem techniques such as optical proximity correction (OPC) and phase shift mask (PSM), exacerbate this problem further.

These differences between the image and the database make the processes of differentiating between “real” (i.e. significant) errors and non significant errors highly heuristic. and hence unreliable or overly strict. Therefore, it also would be desirable to provide a method which avoids repeatable errors, and which is more robust and convenient to use than existing methods.

A further disadvantage of both the Die to Die and Die to Database methods is that the criteria used to declare “significant” differences between the reticle image and the reference image (i.e. the database or second die image) can be relatively far removed from the really significant question of whether the reticle will produce a good wafer (since the reference has not in any way been “proved” correct by creating a good wafer)—this again leads to an overly strict approach in identifying errors, thereby increasing the cost of the reticle manufacture.

In addition, plates or reticles can undergo substantial wear and tear. This is true, for example, in processes employing deep ultraviolet (DUV) wavelengths. The Die to Die inspection method cannot identify the resulting errors adequately. While it would be possible to use the Die to Database method to find such errors, the results are not necessarily as definite as desired.

### SUMMARY OF THE INVENTION

In view of the foregoing, it is one feature of the invention to provide a method of article inspection which avoids repeatable errors.

It is another feature of the invention to provide a method of reticle inspection which is convenient and easy to use, and which further can be distributed or disseminated easily, so as to be shared by various participants in the process of manufacture of semiconductor devices, and wherein the results of the inspections can be correlated.

It is yet another feature of the invention to provide a method of reticle inspection which allows the “significant difference” test to be carried out relative to a proven “good” reference source that was used to create a real wafer.

It is a further feature of the invention to provide an inspection method which permits the identification of time degradation of reticles and other inspected articles, for example, as a result of the use of DUV methods.

It is a still further feature of the invention to provide an inspection method which permits the predicted timing of a replacement for a reticle, based on the identified time degradation.

To achieve the foregoing and other features, in accordance with the present invention, a method and apparatus are provided for inspection of articles through comparison with an image of a master article, which is believed to be substantially free of defects. More specifically, what is described in detail below is a method of inspection for which the term “Master to Reticle Inspection” has been coined. As will be appreciated from the following discussion, for at least a subset of applications in the semiconductor manufacturing industry, Master to Reticle Inspection, or MRI, can be a superior inspection method when compared to conventional methods, such as Die to Die and Die to Database. The MRI method has most of the advantages of both of these classical methods, but few of their disadvantages. Moreover, there are no substantive technical problems to be encountered in implementing the inventive concept.

Indeed, what is involved here is the substitution of an image of a fully inspected and error free reticle, referred to herein as the “master” reticle, for the reference die or database information. Other aspects of image processing, or accounting for misalignments as a reticle is scanned, are common to the invention and to the conventional techniques. Thus, details of such image processing and alignment may be found in the above-referenced patents which have been incorporated by reference.

The basic idea of MRI is to save a gray scale image of a master reticle on some recording medium, for example a digital video disk (DVD). This recorded image then is used as the reference image, instead of a die (as in Die to Die) or database (as in Die to Database). It should be noted that while the term DVD is used, in principle any suitable storage medium can be used, including magnetic media, particularly in view of the high storage capacities and fast access times which current hard disk drives provide. In particular, the present invention builds on the technology roadmap generated for internet and multimedia applications, which also have required very high throughput volumes at high data rates. Moreover, prior to storage, the image data can be compressed using any known compression algorithms. The relative regularity of such plates relative to other high end applications (such as medical imaging) should increase the effectiveness of compression.

### BRIEF DESCRIPTION OF THE DRAWINGS

The invention now will be described in detail below with reference to one or more preferred embodiments, with reference to the accompanying drawings, in which:

FIG. 1 shows a general flow of the steps involved in practicing the inventive method;

FIG. 2 shows a block diagram of apparatus which may be used to practice the invention; and

FIG. 3 shows a further embodiment of apparatus which may be used to practice the invention.

### DETAILED DESCRIPTION OF PREFERRED EMBODIMENTS

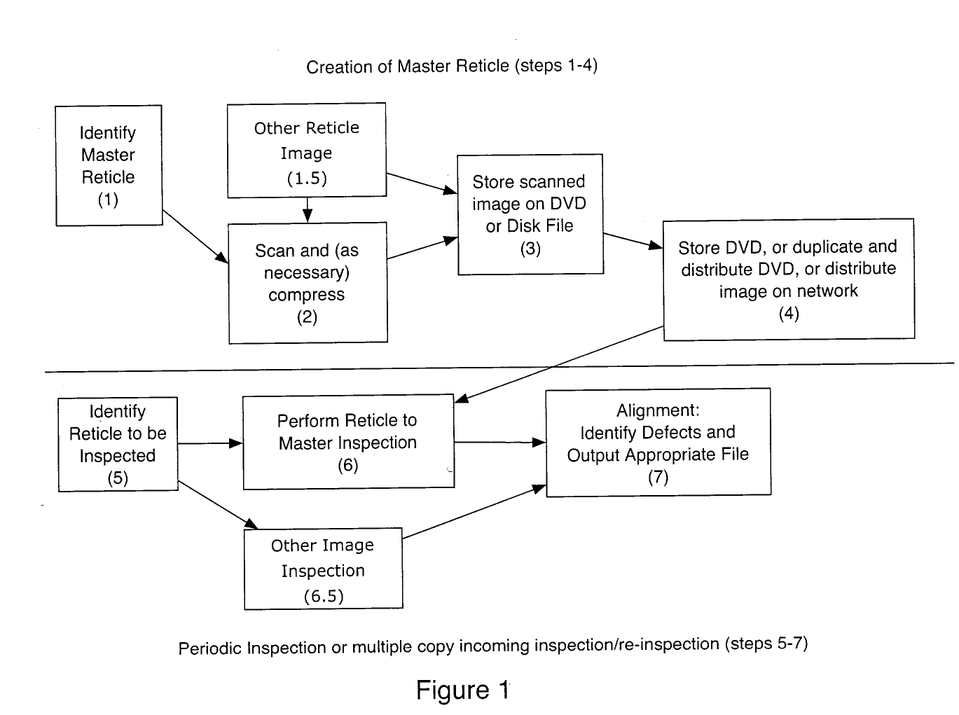

Referring to FIG. 1, the inventive method is implemented as follows. First, a reticle which is known to be good (i.e. is believed to be substantially free of defects, or as free of defects as is reasonably possible) is identified (step 1). While not forming part of the invention, this step is preferably achieved by scanning the reticle in a high resolution inspection system, such as the RT 8200 noted above. Also, preferably the Line Width Error Detector (“LWED”) available on the RT 8000™ series, and in particular in the RT-8200™, is used to measure any line width error on a sub-pixel resolution (the current LWED is capable of detecting line errors at up to 1/32 of the pixel size). Only a reticle that passes the inspection with zero defects detected is identified as the master reticle. However, it should be noted that while the disclosure is provided in terms of a master reticle, in the case where only the die (and not the inter die) area needs to be inspected, it is sufficient to identify a master die, and use an image of the master die for inspection of all dies on the reticles.

In step 2, the master reticle (or die) is scanned to obtain a gray level master reticle (or die). The image of that scan is saved in some non-volatile storage device (step 3). The storage device could contain one or more media such as a DVD or a laser disk. Alternatively, the storage device could be a large file server containing, for example, a magnetic hard disk drive, or a group of disk drives organized in some form of array (e.g. RAID, which stands for Redundant Array of Inexpensive Disks; or JBOD, which stands for “Just a Bunch of Disks”). The largest hard disk drives presently available have storage capacities comparable to that of a DVD, with superior access times. It also is within the contemplation of the invention to provide multiple DVDs on, for example, a jukebox, whereby the various DVDs may be accessible either individually or in groups (depending on the number of readers available in the jukebox). Other media, such as magneto-optical media or laser disks could be employed as well. Key issues are access time and storage capacity. File servers also are currently available that allow terabytes of storage at read rates of tens of megabytes/second.

As memory and other storage prices continue to decrease, and access time to the storage medium becomes increasingly critical (e.g. because scanning speeds continue to increase), it is also within the contemplation of the invention to provide sufficient semiconductor-based memory, be it volatile (e.g. dynamic random access memory, (DRAM)) or non-volatile (e.g. static random access memory (SRAM) or other non-volatile random access memory (NVRAM)) to enable storage even of massively large images in semiconductor memory.

If required, the scanned image that is recorded in step 2 above can be compressed before being stored. The need for and the amount of compression required depends on required image accuracy (taking into account features such as desired inspection time, and available pixel size). Inspection time can be important, because throughput has important significance in the fab environment. There can be time related consequences to working with compressed images as compared with uncompressed images. Different compression algorithms take different lengths of time to expand the master reticle image, and as a result can have an adverse impact on throughput and processing time.

Once the scanned image is compressed (as necessary) and recorded on a DVD or other medium in step 3, the medium is stored, or duplicated and distributed, or otherwise made available (for example, over a local area network (LAN), a wide area network (WAN), a metropolitan area network (MAN), or an intranet, or even over a internet connection) (step 4). Of course, given the sensitive nature of this type of material, transmission over an internet connection probably should entail some reasonable level of encryption.

At the fab, the data can be retained on the DVD (e.g. in a “jukebox”), and directly inspected from there; alternatively, it can be copied to a high performance file system from which the inspection is carried out.

With respect to storage of images of reticles, the invention is not limited to storage of images of master reticles in the manner described. It may be useful to retain images of reticles at various stages of their useful lifetimes, for example, to measure wear, or to analyze various types of systematic errors that may arise as a result of the reticle manufacturing process. Accordingly, it also is within the contemplation of the invention to store images other than the image of a master reticle, in a form in which the stored image may be used for subsequent comparison or analysis. Presently it appears that non-volatile storage of such images would be most desirable in that circumstance, but once again, if memory prices continue to drop, it may be worthwhile to have volatile storage of such images as well.

In the course of using the master reticle, the reticle to be inspected is identified (step 5), and the inspection is done relative to the master (step 6), again using known image processing, alignment, and correction techniques such as have been adapted in the course of implementing the conventional Die to Die and Die to Database methods. Once the inspection is done, a report on defects is produced (step 7). In more specific terms, a system such as the Aris-i™, also available from Applied Materials, may be used to scan an inspected reticle to obtain an image of the inspected reticle. Each pixel of the inspected reticle image then is compared to corresponding pixels from the stored master image. This comparison preferably is done “on the fly” as the inspected reticle is scanned. Accordingly, the pixels of the inspected and master images need to be aligned. Such an alignment can be done using the conventional technique used in the Aris-i™ for aligning pixels of the inspected image with pixels of the database. It should be appreciated that in addition to storing the reference image, the DVD or other storage medium can also include information (such as the location of alignment targets, bar codes and so on) that make alignment and other preinspection calibration easier than in the Die to Die method, which does not have such information available. That information also could be stored elsewhere in the system.

The comparison of the inspected image to the master image is simpler than the comparison to a database. Specifically, since in the inventive method both images are of the same type, i.e., gray scale, no statistical algorithm is necessary digitize the inspected image, or smear the database image. Instead, the gray levels of both images can be compared, and inconsistencies flagged as defects. Alternatively, or in addition, the Aris-i™ algorithm can be used to digitize both inspected and master images, and the LWED can be used to compare the images on a sub-pixel resolution.

The inventive method is useful for the following applications, among others:

1) Periodic Re-inspection of masks in a fab. A reticle may be recorded as part of the incoming acceptance procedure, or the recording may be supplied by the mask shop as part of its service. As the reticle is used, it can be re-inspected relative to the master, thus permitting a direct check of any change in the reticle over time. For example, periodic re-inspection can pick up defects such as global transmission and dust particles. The inventive method also can be used to inspect single die reticles, and can be used to inspect the inter die area—neither of which is done by traditional Die to Die inspection. A history of repeated inspection may show a trend (for example changes in the transparency of the pelicle), thus helping to predict when cleaning, change of pelicle, or re-manufacture of the reticle will be necessary, or as an indication of some problem in the fab environment.

2) Multiple Reticle Inspection. If a fab needs multiple copies of a reticle, or it needs to periodically remanufacture a reticle, then incoming inspection can be done using the inventive method. Multiple copies are needed if multiple steppers are used, or if the wafer is manufactured at different sites. The main advantage here is that the master can be a recording of a mask that was used to create a working tested chip. Unlike other inspection methods, here the inspection is carried out relative to an image that presumably is correct by definition (because it was used to manufacture a chip that works) rather than relative to some arbitrary criteria which may be too strict—thus defining something as a defect which may not be truly significant.

The inventive method is not specific to what data is recorded as a representation of an image of the master reticle. Any suitable data may be recorded, including but not limited to transmitted illumination, reflective illumination, aerial image, or a desired combination thereof, as required.

To implement the inventive method, the scanning of the reticles to obtain an image may be done in any of a number of known ways. The presently preferred way involves the use of a standard scanning method such as the one in the Aris-i™ system currently being offered by Applied Materials.

Once the reticle is scanned, and an image obtained, optionally compressed, and stored, the image processing is carried out in the same manner as is done in the conventional Die to Die method. As might be expected, the degree and nature of the processing required depends on the type of images (reflected, transmitted, aerial or some combination of these).

Binarization of image data, and comparison of the binarized data, may be carried out as in the RT-8200™ or Aris-i™ products.

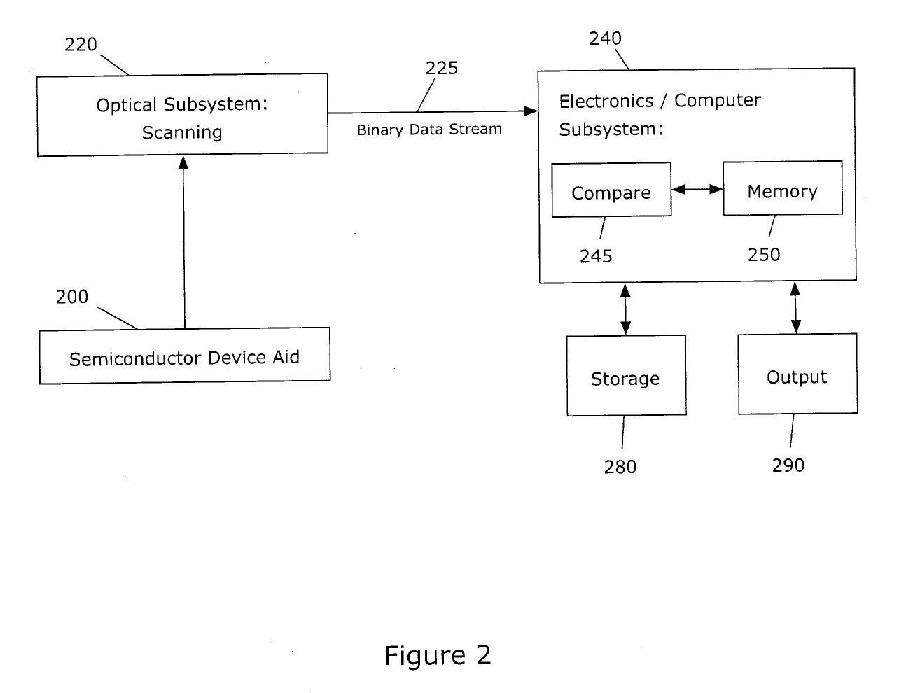

FIG. 2 is a block diagram, showing major components which may be used to practice the invention. In FIG. 2, a mask, photomask, or reticle 200 is scanned using optical subsystem 220. The article 200 preferably is on an x-y stage (not shown). Optical subsystem 220 provides image data to electronics and computer subsystem 240, preferably in a stream of binary data (“binarized data”). The electronics portion of subsystem 240 generates that binary stream, and the computer portion of subsystem 240 compares that binarized stream in a compare unit 245 with a further (second) binarized stream of data.

To this point, the details of electronics/computer subsystem 240 are conventional, and well within the knowledge and abilities of the ordinarily skilled artisan to implement. Any of several such subsystems, as described in various U.S. patents which are referred to throughout, and which are incorporated by reference, may be used.

Where details of subsystem 240 diverge are with respect to the source of the second binarized stream of data. In accordance with the present invention, that second binarized stream of data is placed in memory 250 based on contents of storage device 280, which contains a master image of the article being inspected.

Memory 250 then provides the second binarized stream to compare unit 245. The second binarized stream of data comes from a master image, representing an article 200 that is believed to be substantially free of defects, and previously stored in storage device 280. The computer portion of subsystem 240 then provides an output, indicating any mismatches between the first and second binarized streams of data, to output device 290.

In FIG. 2, for an article 200 that is determined to be substantially free of defects, optical subsystem 220 provides corresponding image data to electronic/computer subsystem 240, which causes that data to be recorded in storage device 280. Storage device 280 thus stores a master version of the article. However, there may be reason to store a version of the article other than a master version, for example, for analysis of degradation of a mask, photomask, or reticle over its useftil lifetime. Storage device 280 can store various versions of an article to facilitate this analysis.

It should be noted that FIG. 2 shows a system which operates in reflective mode. As the ordinarily skilled artisan easily will appreciate, the invention also is amenable readily to implementation in a system which operates in a transmissive mode.

With respect in particular to storage of a master reticle, there are three key questions that need to be addressed:

i) How much compression is required?

ii) How is compression done (when recording the master)?

iii) How is expansion done (when inspecting using the master)?

Answering these questions involves the application of known assumptions regarding availability of compression, implications of expansion, and tradeoffs with processing time and inspection time. The inventive technique is useful with a wide range of pixel sizes; however, with presently available technology, it is believed that the present technique is particularly useful for pixel sizes of 0.4 μm and larger. As scanner technology and associated hardware technology progresses, it is expected that the inventive technique will be applicable for smaller pixel sizes, and hence to smaller geometries in reticles, photomasks, etc.

With respect to compression issues, it is noted that relatively lossy image compression could be acceptable if the noise introduced in this way is:

a) lower than the noise obtained in any rescan of the image (as in Die to Die comparisons); and

b) identifiable in some way so that it is possible to distinguish between noise and defects. Such a distinction might be possible because defects, which are “physical,” affect several pixels in a defined way, whereas noise is likely to be “mathematical,” and thus affect only a single pixel. Possibly a low pass filter or interpolation algorithm can clean up a lot of the noise.

The following discussion summarizes the advantages and disadvantages of the major inspection methods relative to MRI. As can be appreciated, the only evident disadvantage of MRI is that it is not useful for first time (mask shop) qualifications of reticles. That is, for a “new” reticle, the MRI technique is not applicable because the technique requires a known “good” reticle before useful comparison can be performed. On the other hand, the MRI technique is extremely useful for periodic inspection and inspection (at a mask shop or a fab) of reticles that are manufactured more than once. This inability to use the inventive technique at all stages of manufacture is not unusual, and certainly is not unique to this technique. Each of the known methods is useful at a different stage of reticle manufacture and use lifetime.

In this connection, is also should be noted that the MRI technique, like the Die to Database technique, is useful for both single die reticles and multiple die reticles, whereas the Die to Die technique only is applicable where there are multiple dies on the reticle. The Die to Die technique also is limited in this regard because only the die area itself is inspected; the interdie area is not. On the other hand, the Die to Database and MRI techniques enable inspection of the interdie area as well.

The Die to Die and MRI techniques are comparable in that both the reference and the image are the same “type,” thereby yielding a more accurate comparison than in the Die to Database technique, in which representation differences between the die and the database contents (eg. bias, corner rounding) require reduced sensitivity in order to avoid false alarms. Possibly design rules can be used to get around the differences, and reduce the false alarm problem, but this requires additional handling of the database contents, which is unnecessary in the MRI or Die to Die techniques.

There is slightly more data handling overhead with the inventive technique relative to the Die to Die technique, which requires none. However, the added overhead is attributable directly to the need in the MRI technique to compare of reticle to an objective reference, whereas the Die to Die technique involves only what amounts to a “self-comparison” within the same reticle. In any case, any handling overhead can easily be minimized with a “jukebox” of DVDs or by a large file server. From the user's point of view, all that is necessary is to input the identity of the plate (unless the plate is bar coded, in which case even that step becomes unnecessary). The only interaction with the system would be the occasional need to add new disks (or files) to the “jukebox” and remove obsolete disks (or files). This kind of replacement activity would be necessary only when the set of reticles used in the fabs changes.

As was discussed previously, the Die to Die method does not pick up repeatable or “global” errors. These can be critical in reticle inspection, because any errors will be replicated throughout any run using the inspected reticles. The Die to Database technique can pick up “global” errors, because the database is an “absolute” reference, but the above mentioned biasing and corner rounding adjustments, inter alia, mean that the database contents differ inherently from what is on the die. On the other hand, because in the MRI technique the reference inherently is absolute, it will pick up repeatable errors; also, because the reference comes from a digital recording, the MRI technique will not result in degradation errors.

Moreover, the data handling overhead in the MRI technique is comparable to that for the Die to Database technique, which can have the database previously stored. However, the other limitations of the Die to Database technique, relative for example to false alarm settings, biasing, and corner rounding, make that technique less desirable.

The nature of the MRI technique, like the Die to Database technique, using a single reference as they do, is such that sampling noise will be the same from run to run. Also setup data, relating for example to alignment, will be available, basically for the same reason. In contrast, the Die to Die technique will have a different noise reference for each run, because the reference comes from the individual reticle itself. Also, setup data will vary from run to run for the same reason.

Both the MRI and Die to Die techniques will work with various kinds of images, i.e. transmitted, reflected, or aerial images. On the other hand, the Die to Database technique works well with the first two kinds of images, but not with aerial images.

The invention is not limited by the particular type of inspection apparatus being used. For example, it is within the contemplation of the invention to use the inventive MRI technique in connection with inspection of phase shift masks. In such an inspection, interferometers could be used, especially where resolution on a wavelength scale is needed. The ordinarily skilled artisan will be familiar with interferometry techniques, as disclosed for example in U.S. Pat. Nos. 5,563,702 and 5,572,598, which are incorporated herein by reference.

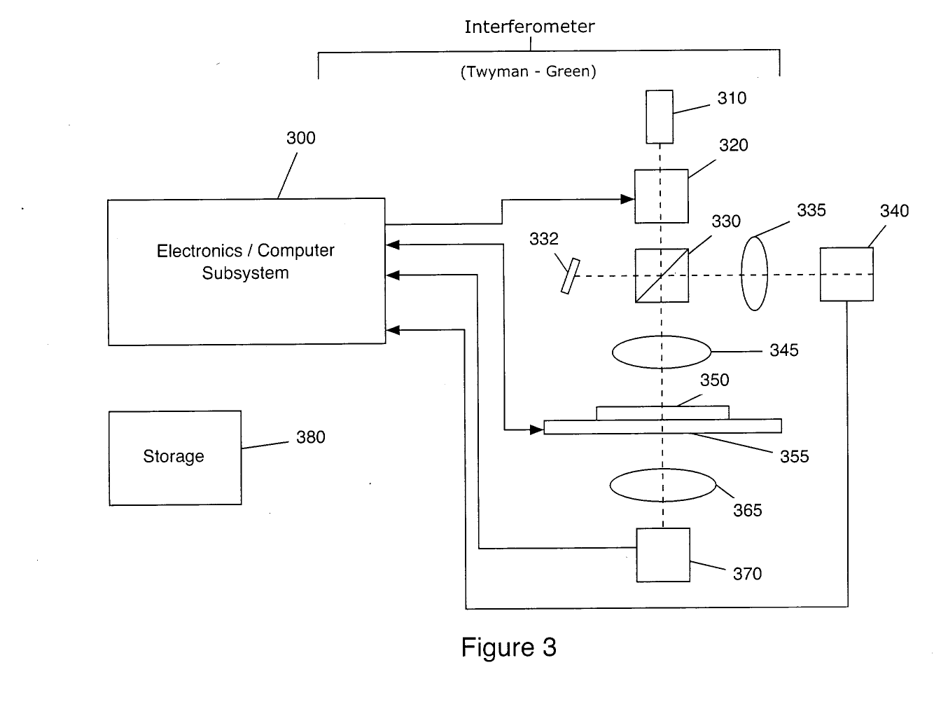

A further example of the invention, as applied to the above-referenced interferometry techniques, is shown in FIG. 3. In that Figure, an electronics and computer subsystem 300, similar to subsystem 240 in FIG. 2, operates in conjunction with an example of an optical subsystem whose components are shown in greater detail in this Figure than in FIG. 2, but with details of other elements omitted. The just mentioned U.S. Pat. Nos. 5,563,702 and 5,572,598 contain information regarding those further details.

FIG. 3 shows light source 310, preferably a coherent source such as a laser. Light source 310 outputs a beam which then enters acousto-optic scanner 320 (and optionally an acousto-optic prescanner, not shown). The emergent beam enters a beam splitter 330. Some of that light is reflected in beam splitter 330 to tilt mirror 332, then back through beam splitter 330 to reflection detector 340.

Light passing through the beam splitter 330 then passes through lens 345, and through article (e.g. mask, photomask, or reticle) 350 on an x-y stage 355 which permits transmission of light. The x-y stage 355 is controlled by subsystem 300 in a known manner. Light passing through article 350 and stage 355 then passes through lens 365 and into transmission detector 370, whose detection output is provided to subsystem 300.

Light which may be reflected from article 350 is also reflected through beam splitter 330, through lens 335, and into reflection detector 340, whose detection output also is provided to subsystem 300.

Because subsystem 300 in FIG. 3 is similar to subsystem 240 in FIG. 2, it will operate similarly to generate binarized streams of data which then may be stored in storage device 380. As in the embodiment of FIG. 2, storage device 380 may store a master image corresponding to the article being scanned, or may store an image of the article itself.

Transmission detector 370 and reflection detector 340 may be CCD devices, of either a 1×N (line) configuration or M×N (area) configuration (M being an integer greater than 1). Light source 310 may be a pulsating laser, as part of the interferometry system, to facilitate inspection of phase shift masks, particularly in conjunction with area CCDs in detectors 370 and 340.

In addition, while FIG. 3 shows both transmission and reflection detection, where purely a reflection detection system is used in phase mask inspection, a Twyman-Green interferometer may be suitable.

While the invention has been described as set forth above with reference to one or more preferred embodiments, various embodiments within the scope and spirit of the invention will be apparent to those of working skill in this technological field. For example, while the preferred embodiment has been described in the context of a reticle used in semiconductor manufacture, it is within the contemplated scope of the invention to apply this simple, powerful technique to inspection of other patterned articles used in semiconductor manufacturing, or even to semiconductor wafer inspection. Indeed, the inventive method and apparatus are applicable equally to inspection of masks, photomasks, reticles, or any other such product used in similar fashion in the manufacture of semiconductor devices, as for example by a photolithographic process. Hence, so far as the inventive method and apparatus are concerned, these terms, and terms defining similar articles, are interchangeable, and should be so understood by those of working skill in this field.

In the case of wafer inspection, there are process-related variations which can arise, which potentially could make a master wafer image less useful, particularly over a long process run. In order to make the inventive scheme work for wafers as well as for reticles, further processing of the imaged wafers to account for process variables may be necessary. Once those process variables are accounted for, as the inventive technique presently is contemplated, it would seem that the MRI technique would be able to work for wafer inspection as well as for reticle inspection, with the attendant advantages.

The invention also is not limited by the degree of “perfection” currently obtainable in the identification of a master article. It is expected that techniques for obtaining and/or identifying “perfect” versions of master articles will improve. The flexible technique of the invention avails itself of such improvements, and correspondingly will yield improved results in semiconductor manufacture.

What is claimed is:

1. A method of inspecting articles related to semiconductor manufacture comprising:
a) creating a defect free master image by losslessly imaging a defect free article and storing such defect-free master image;
b) imaging the article under inspection;
c) comparing the image of article under inspection with the defect-free master image;
d) outputting the results of the image comparison, specifically identifying locations of image deviations.

2. A method as in claim 1 wherein the storage of the defect free master comprises recording on some digital storage medium.

3. A method as in claim 1 where the article is one of a mask, a photomask or a reticle.

4. A method as in claim 1, where the imaging of the article under inspection further includes:
binarizing the scanned image and generating a first digital data stream binarizing the defect free master image and generating a second digital data stream comparing the first and second digital data streams.

5. A method as claimed in 1, comprising the following additional step:
b1) after said step b), making defect free master image version available to users in remote locations, such that said users can perform said steps c and d using said image of said master version.

6. A method as claimed in claim 5, wherein said step b1) comprises the step of placing said defect free master image on at least one of: a local area network; a wide area network and an intranet.

7. A method as claimed in claim 6, wherein said step b1) comprises the step of placing said image of said master version on a plurality of removable storage media and distributing said removable storage media.

8. A method of obtaining a recorded image of a defect free master article for comparison with correspondingly-patterned articles to identify possible defects and thereby avoid replication of said defects during manufacture of semiconductor devices, said method comprising:
a) identifying said defect free master article to be used in the course of said comparison by inspection of product produced by said defect free master article;
b) scanning said defect free master article to obtain an image thereof; and
c) recording said image of said defect free master article on a storage medium;
such that said image recorded on said storage medium is of a form in which it can be compared with a correspondingly patterned article to identify possible defects in said correspondingly-patterned article, so as to avoid replication of said defects during said manufacture of said semiconductor devices.

9. A method as claimed in claim 8, wherein said semiconductor devices are manufactured using a photolithographic process.

10. A method as claimed in claim 8, wherein said master article has at least one chrome and glass pattern formed thereon.

11. A method as claimed in claim 8, wherein said step c) comprises recording said image of said master article on at least one of: a laser disk, a digital video disk (DVD), a jukebox of DVDs, a magnetic hard disk drive, a magneto-optical storage medium, a “redundant array of inexpensive disks” (RAID)-based system, or a “just a bunch of disks” (JBOD)-based system.

12. A method as claimed in claim 8, wherein both said defect free master article and said correspondingly-patterned article are one of a reticle, a mask, or a photomask.

13. A method as claimed in claim 8, wherein said step c) compromises recording data relating to setup for inspecting said correspondingly-patterned article, including alignment data.

14. A method of inspecting an article having a pattern forming a plurality of die designs thereupon, said pattern being used in the manufacture of semiconductor devices, said method comprising:
a) inspecting at least one article to identify a die which is demonstrably defect free;
b) obtaining a master image of the die;
c) recording the master image onto a storage medium;
d) obtaining an inspected image of a die of the article to be inspected; and
e) comparing the inspected image to the master image and identifying as defective each location of the inspected image that is inconsistent with a corresponding location on the master image, so as to avoid replication of defects during said manufacture of said semiconductor devices

15. A method as claimed in claim 14, wherein said pattern is a chrome and glass pattern for the manufacture of said semiconductor devices.

16. A method as claimed in claim 15, wherein said semiconductor devices are manufactured using a photolithographic process, said article being used in said photolithographic process

17. A method as claimed in claim 15, wherein said article is one of a reticle, a mask or a photomask

18. An apparatus for inspecting specimen patterned articles where such patterns have been transferred to the articles during the manufacture of semiconductor devices and where such inspection is compared against a defect free image created by a high resolution scan of such a patterned article and where such scanned article and resulting scan are determined to be error free, said apparatus comprising:
(A) a high resolution scanning device which creates images of the patterned articles;
(B) non-volatile recording media operate to record images of patterned articles, both specimen articles and defect free articles.

19. An apparatus as in claim 18 further comprising:
(C) a processing apparatus
C.1 operable to binarize a specimen article image and to generate a first digital stream;
C.2 operable to binarize a defect free article image and to generate a second digital data stream;
C.3 and which compares the first and second digital data streams;
D. an output device operable to output indicating degree of matching between first and second digital datastreams.

20. An apparatus as claimed in claim 19, wherein said scanning device comprises an interferometer.

21. An apparatus as claimed in claim 20, wherein said interferometer is a Twyman-Green interferometer.

22. An apparatus as claimed in claim 19, wherein said imaging device comprises a transmitted light detector, said transmitted light detector providing outputs to said processing device to produce said first stream of binarized data.

23. An apparatus as claimed in claim 22, wherein said imaging device further comprises a reflected light detector, said reflected light detector providing output to said processing device along with said transmitted light detector to produce said first stream of binarized data.

24. An apparatus as claimed in claim 22, wherein said transmitted light detector is a charge-coupled device (CCD).

25. An apparatus as claim in claim 24, wherein said reflected light detector is a CCD.
